(19) United States
(12) Patent Application Publication
(10) Pub. No.: US 2007/0211046 A1
(43) Pub. Date: Sep. 13, 2007

(54) System and method for calibration of ambient light sensor brightness output

(76) Inventors: Erin L. Taylor, Pflugerville, TX (US); John Billingsley, Groesbeck, TX (US)

Correspondence Address: HAMILTON & TERRILE, LLP, P.O. BOX 203518, AUSTIN, TX, 78720, US

(21) Appl. No.: 11/370,312

(22) Filed: Mar. 8, 2006

(51) Int. Cl. G09G 5/00

(52) U.S. Cl. 345/207

(57) ABSTRACT

Information handling system display brightness adjustments in response to ambient light sensed by an ambient light sensor are calibrated by reference to brightness levels, such as manually selectable brightness levels stored on the display. A brightness calibration module running on the information handling system or a controller of an inverter associated with the display generates an ambient light response from the manually selectable brightness levels, such as with a piecewise linearization of each pair of sequential manually selectable brightness levels. The inverter automatically adjusts display brightness by correcting ambient light levels sensed by the ambient light sensor according to the ambient light response.

### BACKGROUND OF THE INVENTION

1. Field of the Invention

The present invention relates in general to the field of information handling system display brightness, and more particularly to a system and method for calibration of ambient light sensor brightness output.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Typically, information handling systems present information to end users through a display. One common type of display is a liquid crystal display (LCD) which uses liquid crystals to selectively pass varying amounts of red, green and blue light at each of plural pixels to present desired colors. LCDs generally are illuminated with a backlight, such as a CCFL, that runs along one or more edges of a display area. The backlight is generally powered by an inverter that provides a high voltage alternating current from a DC-to-AC inverter power supply. Because LCD panels are both energy efficient and compact, they are typically selected for use as portable information handling system integrated displays. Since portable information handling systems are often carried by end users to various locations with different levels of ambient light, the brightness at which a display panel is illuminated is generally manually selectable by an end user, such as with eight levels sequentially selected with a function up arrow or function down arrow keyboard input. Typically, the various display panels are set so that the brightness level at each of the eight manually selected levels is substantially similar.

Manually adjusting display brightness is often a hassle for end users since it usually requires two hands and the display image is sometimes not visible until after an adjustment is made. Ambient light sensors (ALS) help to avoid the need for manual brightness adjustments by sensing ambient light and automatically applying the sensed ambient light to adjust display brightness. ALS adjustments are typically performed with greater numbers of increments having smaller increment sizes than manual adjustments. For instance, 256 nit values are generally available for adjusting brightness settings output by the inverter with the eight manual settings selected from these increments to have defined brightness levels. However, the response of the ALS adjustments may vary widely at different brightness levels. These variances result in part due to imprecise tolerances found in ALS devices and also due to varying visual impacts that result from ALS adjustments at different nit values and with different display panels. Variance in an ALS response curve for different types of display panels makes it difficult to adapt a common ALS device for use in multiple types of display panels. However, calibration of an ALS device specifically for each type of display panel is prohibitively time consuming and expensive.

### SUMMARY OF THE INVENTION

Therefore a need has arisen for a system and method which automatically adapts an ALS device response to obtain consistent display panel brightness output.

In accordance with the present invention, a system and method are provided which substantially reduce the disadvantages and problems associated with previous methods and systems for calibrating display panel brightness output. An ambient light sensor response is modified by reference to preset brightness values that output known brightness from an information handling system display. Brightness of the display is then maintained with the modified ambient light sensor response so that the brightness output by different types of displays is substantially calibrated when under management of the ambient light sensor.

More specifically, manually selectable brightness levels are stored at a display in a brightness step table, such as in Electronic Extended Device Identification Data (EEDID) or nonvolatile memory associated with the display inverter. User inputs to manually select a brightness level are performed by retrieving the brightness step table and applying an sequential SMBus value associated with a selected brightness to the inverter. Alternatively, display brightness is automatically adjusted by ambient light sensor measurements of ambient light provided to the inverter. A brightness calibration module modifies the ambient light sensor response to provide a consistent brightness output for different types of displays. For instance, a linearization method produces a modified ambient light sensor response by reference to manually selectable brightness levels. In one embodiment, piecewise linearization based on each pair of sequential manually selectable brightness levels generates a composite ambient light sensor response calibrated so that automatically set brightness under management of the ambient light sensor is consistent with the brightness provided by preset levels.

The present invention provides a number of important technical advantages. One example of an important technical advantage is that ALS device response automatically adapts to calibrate brightness output for different types of display panels during variations of ambient light. Estimating ambient light response based on manual brightness levels provides predictable and consistent responses across different types of display panels without requiring calibration of each type of display panel. Thus, a single ALS device integrates into multiple different types of display panels to reduce the complexity and expense associated with design and repair of display panels. For instance, a common ALS device is integrated into the inverters of plural types of display panels to reduce the number of parts needed for manufacture of an information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system having an integrated display with calibrated ambient light sensor brightness adjustments;

FIG. 2 depicts a table of example display panel brightness step differences for eight defined luminance values;

FIG. 3 depicts an example of an ALS output brightness response for ambient light levels versus SMBus sequential brightness step values;

FIG. 4 depicts a block diagram of a system for calibration of ambient light sensor output for an information handling system display; and

FIG. 5 depicts an example of an ambient light sensor response modified based on manually selectable brightness levels.

### DETAILED DESCRIPTION

Calibration of ambient light sensor outputs to an information handling system display by reference to manually selectable brightness levels provides consistent automated brightness adjustments for a variety of display types. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

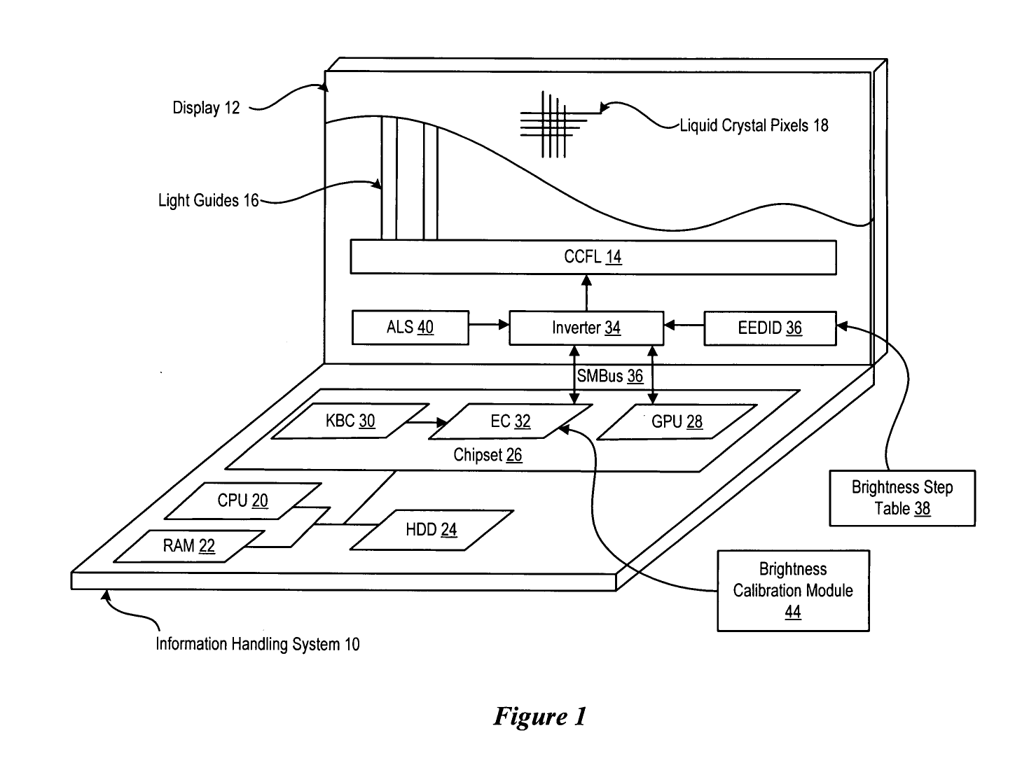

Referring now to FIG. 1, a block diagram depicts a portable information handling system 10 having an integrated display 12 with calibrated ambient light sensor brightness adjustments. Display 12 is a liquid crystal display that illuminates images with a backlight 14, such as a CCFL or LED backlight, that provides light through light guides 16 across liquid crystal pixels 18. Images are generated with pixels 18 based on visual information provided by processing components running on information handling system 10, such as a CPU 20, RAM 22, a hard disk drive 24 and chipset 26. For instance, an application running on CPU 20 provides visual information to a graphics processor unit 28, which applies the visual information to determine the color allowed to illuminate from each pixel 18. End users communicate with the processing components through input/output devices, such as a keyboard or mouse, interfaced with a key board controller 30 or an embedded controller 32 of chipset 26.

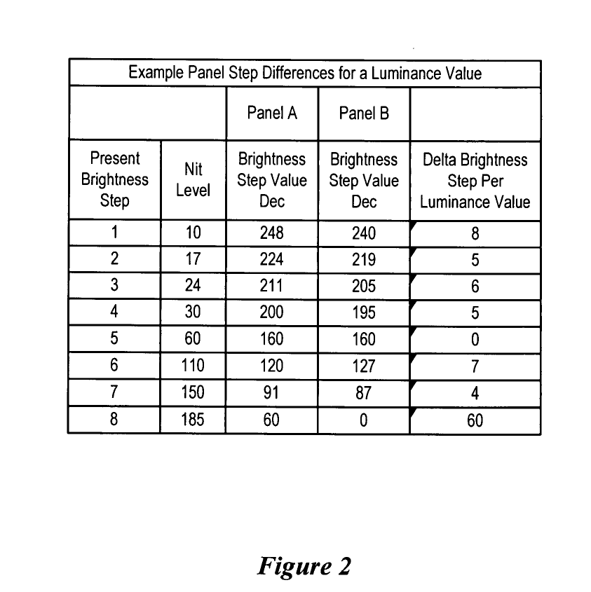

The brightness at which display 12 is illuminated by CCFL 14 is determined by the power output from inverter 34. In one mode, display brightness is manually controlled with preset brightness step levels through user inputs of function up arrow to increase brightness and function down arrow to decrease brightness. For instance, FIG. 2 depicts a table of example display panel brightness step differences for eight defined luminance values. The power from inverter 34 is commanded through an SMBus 36 in 256 increment values. In alternative embodiments, different sequential values might be used, such as with analog control structures that use a PWM signal having duty cycles between 0 and 100%. In such analog control structures, the duty cycle is, for instance, equated to a nit value for use by digital processors. At the first manually selectable brightness level, both Panel A and Panel B illuminate at 10 nits, however Panel A has an sequential value of 246 communicated from chipset 26 to inverter 34 while Panel B has an sequential value of 240. Thus, in order to have the calibrated brightness of 10 nits, Panels A and B communicate values having a difference of 8 to inverter 34. By comparison, in order to have the calibrated brightness of 185 nits, Panels A and B communicate values having a difference of 60. The eight manually selectable brightness levels for each display 12 are stored in EEDID 36 of display 12 as a brightness step table 38. To support manual user selection of a brightness level, embedded controller 32 retrieves brightness step table 38 and provides the SMBus sequential brightness step value to inverter 34 that will output the brightness associated with the manually selected brightness level. For instance, selection by an end user of brightness step 3 will provide a brightness level of 24 nits at Panels A and B by communicating an SMBus value of 211 for Panel A and 205 for Panel B.

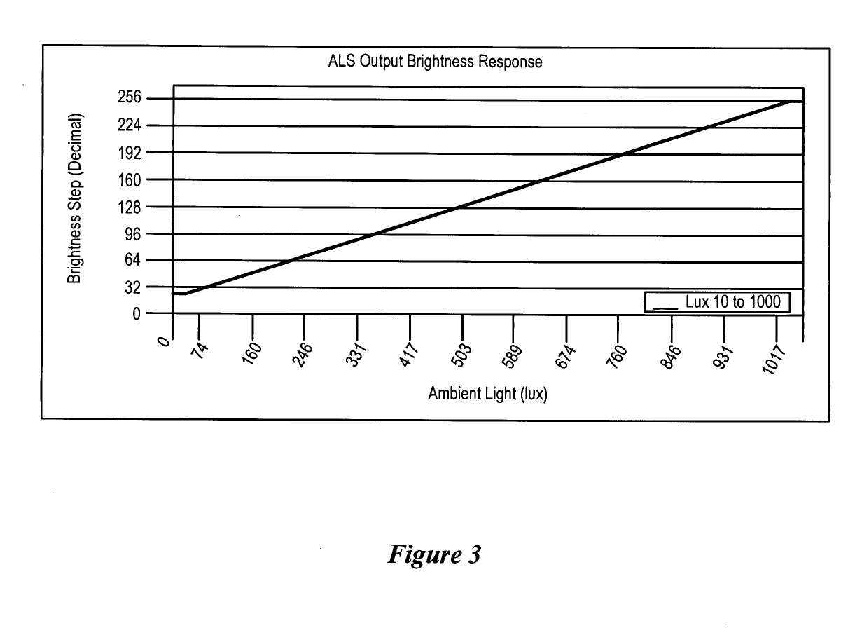

In an automated mode, display brightness is automatically adjusted to adapt to varying ambient light conditions as sensed by an ambient light sensor (ALS) 40. For instance, FIG. 3 depicts an example of an ALS output brightness response for ambient light levels from 10 to 1000 Lux of luminance versus SMBus sequential brightness step values of 0 to 256. In operation, as ALS 40 senses an ambient light level, the brightness step value associated with the ambient light level is provided to inverter 34 to command the brightness of the step value. For instance, at an ambient light level of around 500 Lux, a brightness step value of 128 is communicated by ambient light sensor 40 to inverter 34. In order to calibrate the brightness automatically output by ambient light sensor 40 for different types of displays, such as the Panels A and B of FIG. 2, a brightness calibration module 44 applies the manually selectable brightness levels from brightness step table 38 to modify the ambient light sensor response. For instance, brightness calibration module 44 is firmware running in the BIOS supported by chipset 26 that reads EEDID 36 values and applies the eight manually selectable brightness levels to modify the ambient light sensor response for the given display. Chipset 26, such as embedded controller 32, monitors ambient light sensed by ambient light sensor 40, adjusts the detected ambient light to the modified ambient light response and provides the sequential brightness step value of the modified ambient light response as an SMBus value to inverter 34. Thus, for example, a modified ambient light response that called for an sequential brightness step value of 211 for Panel A of FIG. 2 would provide a value of 205 for Panel B so that Panels A and B illuminate at a consistent brightness in the same ambient light conditions.

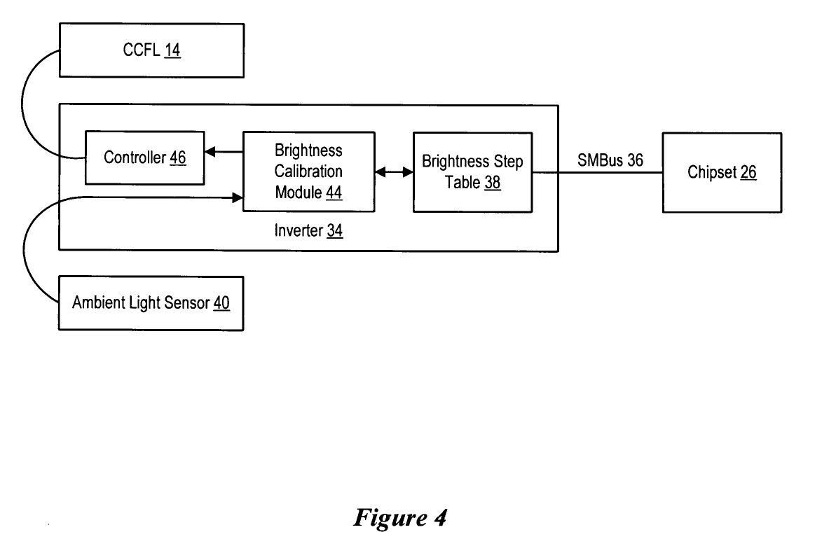

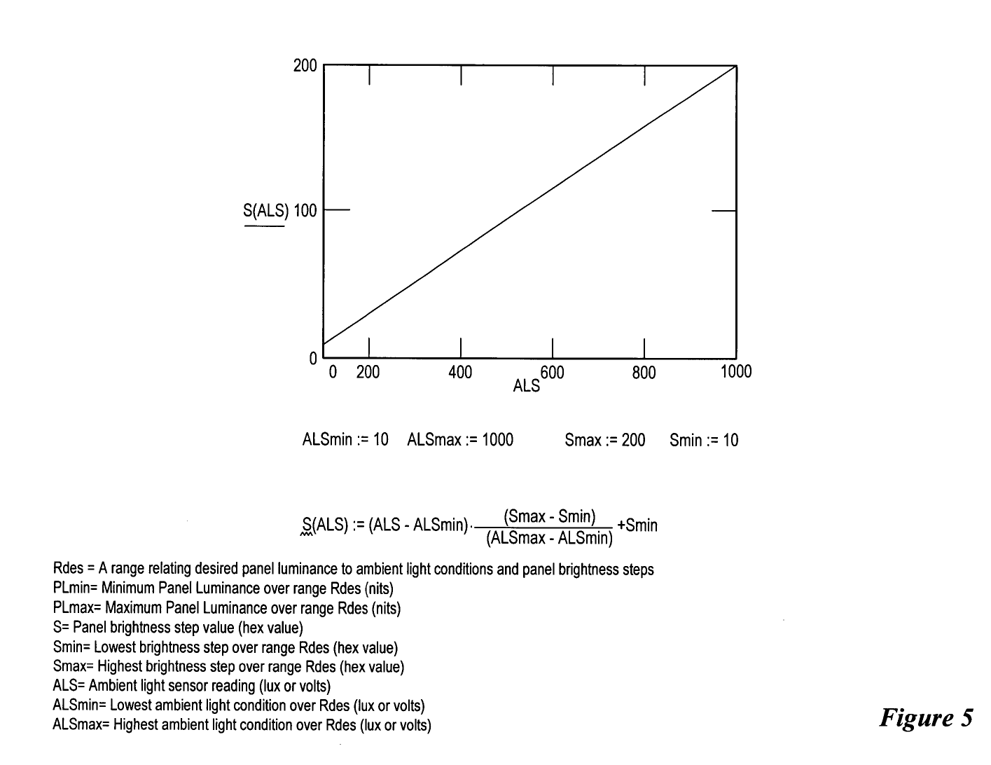

Referring now to FIG. 4, a block diagram depicts an alternative embodiment of a system for calibration of ambient light sensor output. Brightness calibration module 44 is included as firmware that runs on a controller 46 of inverter 34. Brightness step table 38 is included in nonvolatile memory of inverter 34 and readable by chipset 26 through SMBus 38. Brightness calibration module 44 modifies the brightness output in response to sensed ambient light using controller 46 so that interaction across SMBus 36 with chipset 26 is reduced. Chipset 26 retrieves brightness step table 38 as needed to enable user selected brightness levels. FIG. 5 depicts a graph and related equations for generating a modified ambient light sensor response based upon brightness output from the display at preset step values, such as manually selectable brightness levels. Essentially, the modified ambient light sensor response S(ALS) is calculated using a linearization method that determines the resulting line from the unmodified ALS response based on two brightness steps having known values. For example, in one embodiment brightness step table 38 is held in two registers located on inverter 34 that store a minimum and maximum brightness step value and controller 46 applies the linearization method to calculate a modified ALS response from these two values. In an alternative embodiment, nonvolatile memory stores the eight manually selectable brightness levels in brightness step table 38 and controller 46 applies a piecewise linearization to these values to determine the modified ALS response. For instance, linearization is applied to each sequential manually selectable brightness level, such as from level 1 to level 2 followed by level 2 to level 3, etc . . . A composite ALS response built piecewise between each sequential pair of preset brightness levels provides a more accurate estimate of a calibrated ALS response relative to all known display brightness levels.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to generate visual information for presentation at a display;
a display interfaced with the processing components and operable to present the visual information as an image with variable brightness levels;
an ambient light sensor operable to detect ambient light levels proximate the display;
a brightness step table having plural manually selectable display brightness levels; and
a brightness calibration module interfaced with the display, the ambient light sensor and the brightness step table, the brightness calibration module operable to apply the manually selectable brightness levels and detected ambient light levels for adjusting the display brightness levels calibrated to a predetermined ambient light response.

2. The information handling system of claim 1 wherein the brightness step table comprises a table stored in an EEDID of the display.

3. The information handling system of claim 2 wherein the processing components comprise a chipset and the brightness calibration module comprises firmware running on the chipset operable to read the brightness step table from the EEDID, to read the ambient light level sensed by the ambient light sensor, to modify the sensed ambient light level by a calibration factor determined from the brightness step table and to provide the modified sensed ambient light level to the display to adjust the display brightness.

4. The information handling system of claim 3 wherein the calibration factor comprises a piecewise linearization between sequential manually selectable display brightness levels.

5. The information handling system of claim 1 wherein the display comprises an inverter having a controller, the brightness step table stored at the inverter and accessible by the controller, the brightness calibration module comprising instructions running on the controller operable to receive ambient light levels from the ambient light sensor, to modify the sensed ambient light level by a calibration factor determined from the brightness step table and to provide the modified sensed ambient light level to the inverter to adjust the display brightness.

6. The information handling system of claim 5 wherein the brightness step table comprises a first register having a first brightness level and a second register having a second brightness level, the calibration factor comprising a predetermined relationship between the first and second brightness levels.

7. The information handling system of claim 5 wherein the processing components comprise a chipset, the chipset operable to receive inputs for manual user brightness selections, to retrieve the brightness step table and to apply the manual user brightness selections to set the display brightness.

8. A method for calibrating ambient light sensor brightness outputs at an information handling system display, the method comprising:
retrieving a brightness step table from the display, the brightness step table having plural preset brightness levels;
applying the preset brightness levels to generate an ambient light sensor response;
receiving ambient light levels sensed by the ambient light sensor;
adjusting the ambient light levels by the ambient light sensor response; and
applying the adjusted ambient light levels to set the information handling system display brightness output.

9. The method of claim 8 wherein applying the preset brightness levels to generate an ambient light sensor response further comprises performing a piecewise linearization between each of plural sequential preset brightness levels.

10. The method of claim 8 wherein:
retrieving a brightness step table from the display further comprises retrieving a minimum brightness step level and a maximum brightness step level; and
applying the preset brightness levels to generate an ambient light sensor response further comprises estimating the ambient light sensor response between the minimum and maximum brightness step levels.

11. The method of claim 10 wherein the minimum and maximum brightness step levels are stored at registers of an inverter of the display.

12. The method of claim 8 further comprising:
receiving a user input of a preset brightness level;
retrieving the preset brightness level from the brightness step table; and
applying the preset brightness level to set the display brightness.

13. The method of claim 12 wherein the brightness step table comprises EEDID of the display and applying the preset brightness levels to generate an ambient light sensor response is performed at a chipset of the information handling system.

14. The method of claim 12 wherein the brightness step table comprises nonvolatile memory of an inverter of the display and applying the preset brightness levels to generate an ambient light sensor response is performed at a controller of the inverter.

15. A system for calibrating ambient light sensor output to an information handling system display, the system comprising:
a brightness step table having plural manually selectable brightness levels;
an ambient light sensor operable to detect ambient light levels;
a brightness calibration module operable to generate an ambient light response from the manually selectable brightness levels; and
an inverter interfaced with the ambient light sensor and the brightness calibration module, the inverter operable to power a display at plural brightness levels, the inverter setting display brightness level with the detected ambient light level adjusted by the ambient light response.

16. The system of claim 15 wherein the brightness calibration module generates the ambient light response from a piecewise linearization of each sequential pair of manually selectable brightness levels.

17. The system of claim 15 where the brightness calibration module generates the ambient light response from a minimum brightness level and a maximum brightness level.

18. The system of claim 15 wherein:
the brightness step table comprises EEDID stored on the display; and
the brightness calibration module comprises firmware running on a chipset of the information handling system.

19. The system of claim 15 wherein:
the brightness step table comprises nonvolatile memory of the inverter; and
the brightness calibration module comprises firmware running on a controller of the inverter.

20. The system of claim 19 wherein the brightness step table is accessible by the information handling system to support end user manual brightness selection.
